(19) United States
(12) Patent Application Publication
(10) Pub. No.: US 2005/0159856 A1
(43) Pub. Date: Jul. 21, 2005

(54) Method and system for exchanging data between control devices

(75) Inventors: Aytac Daghan, Regensburg (DE); Franz Plattner, Arnschwang (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 11/039,027

(22) Filed: Jan. 20, 2005

(30) Foreign Application Priority Data
Jan. 20, 2004 (DE) 10 2004 002 911.3

(51) Int. Cl. G06F 17/00

(52) U.S. Cl. 701/1; 307/10.1

(57) ABSTRACT

A method and a system for exchanging data between at least one vehicle-mounted control device and a portable hand-held device, for example in the form of a key in which software for transmission to the at least one vehicle-mounted control device is stored.

### BACKGROUND OF THE INVENTION

Field of the Invention

The invention relates to a method and a system for exchanging data between control devices, particularly for updating software of control devices in a vehicle.

A vehicle manufacturer or a supplier of electronic control devices must be able to update the software and/or the software settings of one or more control devices in the vehicle when required. The reason for this can be the requirement to expand functions, or to change or expand software settings, or for example the need to debug software faults in electronic control devices.

If the vehicle is already with the end consumer, the consumer must find a workshop to expand the software functionalities.

If a software fault is to be rectified, a “recall” is necessary in the majority of cases to debug the fault, with the owner or operator being informed in writing by the vehicle manufacturer to take the vehicle to a workshop authorized by the vehicle manufacturer. Recalls of this kind are expensive for the vehicle manufacturer or his suppliers.

German patent DE 195 32 067 C1 and corresponding U.S. Pat. No. 5,838,251 describe a method and a device for programming operating data in vehicle components, with the data being required by the particular vehicle component if it is to operate properly. For this purpose, data for the vehicle components is held available centrally, and is sent on request, with a code specific to the vehicle component, to the requesting body, with the decoding taking place only in the vehicle component itself. This guarantees a higher protection of the data to be programmed into the component against unauthorized attacks during transmission.

German published patent application DE 101 43 556 A1 refers to a vehicle management system with a control computer connected to the vehicle and a central control point connected via a wireless interface to the control computer, with the control computer having a communication unit for providing and storing the data to be transmitted via the wireless interface and also having a data bus interface to capture the various sensor data via the data bus of control devices arranged in the vehicle.

German published patent application DE 102 07 858 A1 and corresponding patent application publication U.S. 2003/0157975 A1 describe a method and a system for the provision of information and communication in vehicles, for example via laptops, PDA or mobile radio devices.

German utility model DE 295 09 741 U1 discloses a system for the exchange of data between at least one vehicle-mounted control device and a portable hand-held device, in which software for transmission to at least one vehicle-mounted control device is stored.

German published patent application DE 199 62 629 A1 discloses a device for controlling an actuating unit, containing an immobilizer that permits a gas exchange valve of an internal combustion engine of a motor vehicle to be controlled depending on proof of access authorization for the vehicle.

German patent DE 198 52 016 C1 discloses a device for securing a vehicle against unauthorized use.

German published patent application DE 198 06 237 A1, as well as corresponding U.S. Pat. No. 6,631,396 and patent application publication U.S. 2002/165904 A1, disclose a method for communication between two EDP systems.

German published patent application DE 197 37 369 A1 discloses a device for securing a vehicle against unauthorized use by means of a budget control device that permits operation of the vehicle only as long as a budget stored in it is not exceeded.

### SUMMARY OF THE INVENTION

It is accordingly an object of the invention to provide a method and a system for exchanging data between control devices which overcomes the above-mentioned disadvantages of the heretofore-known devices and methods of this general type and which provides for a simple and reliable method and system for updating the software of control devices in a vehicle, without the vehicle having to be brought to an authorized workshop for the software to be updated.

With the foregoing and other objects in view there is provided, in accordance with the invention, a system for the exchange of data between a vehicle-mounted control device and a portable device having software for transmission to the vehicle-mounted control device stored therein, wherein the portable device has a diagnostic unit for identification of software in the vehicle-mounted control device.

In accordance with a system in accordance with the invention, data is exchanged between control devices of a vehicle, with one of the control devices being in the form of a portable programmable hand-held unit. Software for transmission to at least one of the other control devices in the vehicle is stored in this hand-held unit. This means that an expensive stay in a workshop is not necessary because for example the vehicle manufacturer can program the portable programmable hand-held unit with the latest software for a particular control device and send it to the end customer, for example by post.

In accordance with a development of the invention, the portable programmable hand-held unit is designed as a key (vehicle key), whereby data (software) can be transferred between the key and a control device in the vehicle when the key is, for example, inserted into the ignition lock of the vehicle or is in its vicinity. By means of the ignition lock, the vehicle electronic system is, for example, supplied with power. The ignition lock preferably contains a transponder coil, via which the key can communicate and which, for example, supplies the key with power.

With the above and other objects in view there is also provided, in accordance with the invention, a method for exchanging data between control devices for a vehicle, the method which comprises:
reading a software version of at least one vehicle-mounted control device with a portable hand-held device;
comparing the software version of the vehicle-mounted control device with a software version stored in the hand-held device,
by means of a diagnostic unit of the portable hand-held device; and
if the software version of the vehicle-mounted control device is older than the software version stored in the hand-held device, transmitting the software stored in the hand-held device to the at least one vehicle-mounted control device.

In other words, the key reads the software version of at least one vehicle control device and compares it with a software version stored in the key. The read software is then only replaced by the software stored in the key if the read version of the software is older.

In accordance with the invention, the vehicle manufacturer/supplier can thus simply transmit the update of the software to the particular vehicle keeper in the form of a key. After the customer has inserted the key in the ignition lock, a software update of one or more of the control devices in the vehicle, programmed into the key by the vehicle manufacturer/supplier, can be carried out. The key can be used for other programming operations. After it is been returned, this key can be reused for further/other software updates.

For a vehicle manufacturer, this is an inexpensive solution to fault debugging or expanding software functionalities of electronic control devices in a vehicle, because the end customer does not have to bring the vehicle to an authorized workshop of the vehicle manufacturer and the vehicle manufacturer does not have to bear the cost of the authorized workshop.

Other features which are considered as characteristic for the invention are set forth in the appended claims.

Although the invention is illustrated and described herein as embodied in a method and system for exchanging data between control devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic block diagram of a preferred exemplary embodiment of the system in accordance with the invention; and

FIG. 2 is a flow diagram to explain the functioning of the system in accordance with the invention according to an exemplary embodiment of the method in accordance with the invention.

### DESCRIPTION OF THE PREFERRED EMBODIMENTS

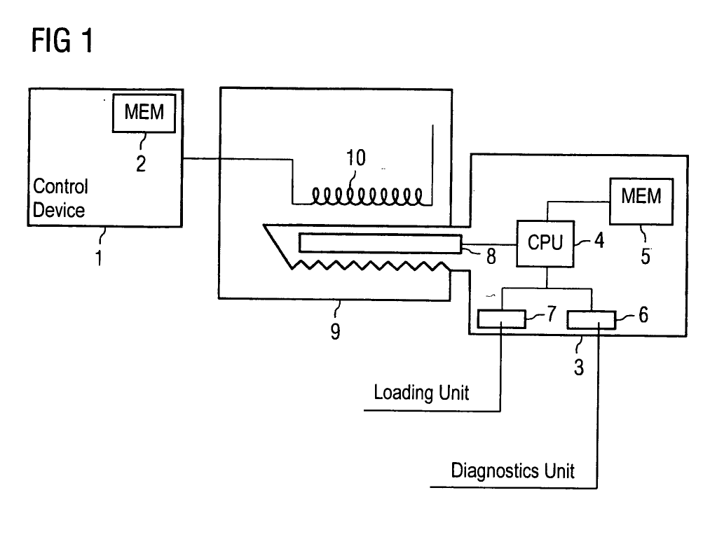

Referring now to the figures of the drawing in detail and first, particularly, to FIG. 1 thereof, there is shown a block diagram of a system for exchanging data between vehicle control devices. A control device 1 with a memory 2, in which the software required to control the control device is stored, is permanently fitted to a non-illustrated vehicle.

FIG. 1 also shows a portable hand-held unit in the form of a key 3, particularly in the form of a vehicle key. The key 3 is clearly distinguishable from the actual vehicle key by color, or some other form of identification. This key 3 does not enable access to the vehicle or enable the vehicle to be started.

A key 3 contains a CPU 4 for control of the complete data communication between the control device 1 and the key 3. The key 3 also has a memory 5, for example a RAM, in which, for example, a software version, updated by the vehicle manufacturer, of the software stored in the memory 2 of the control device 1 is stored.

The key 3 also contains a diagnostic unit 6 for identification of the software stored in the memory 2 of the control device 1 and a loading unit 7, to transfer the current software version, stored in the memory 5 of the key 3, to the memory 2 of the control device 1, and thus replace the old software version by the new software version or expand its function.

Communication between the control device 1 fitted in the vehicle and the key 3 takes place via a transponder interface 8 formed in the key, with communication between the control device 1 and key 3 preferably then taking place when the key 3 is fully inserted into the ignition lock 9 of the vehicle. Alternatively, it is also possible that communication between the control device 1 and the key 3 already takes place when the key 3 is only in the vicinity of the ignition lock 9.

When the key 3 is fully inserted into the ignition lock 9, the key 3 is, for example, engaged in the ignition lock 9 until the transmission of data between the key 3 and control device 1 has been completed. This prevents an unwanted interruption in the data transmission and makes sure that the software contained in the memory 2 of the control device 1 always has a complete functionality.

The electronic ignition lock 9 in the vehicle has a transponder coil 10 via which communication with the transponder interface 8 of the key 3 is possible. The transponder coil 10 is connected to the control device 1 fitted in the vehicle and, for example, supplies the key 3 with power.

Although FIG. 1 shows only one control device 1 fitted in the vehicle, a complete group of control devices 1 can, for example, be connected to the transponder coil 10 in the electronic ignition lock 9 and communicate with the key 3. Thus, for example, different current control programs can be contained in the memory 5 of the key 3, in order to update or expand the software in the corresponding memories of the control devices. These vehicle-mounted control devices can, for example, be connected by a control device bus and be addressed individually. Thus, several control devices fitted in the vehicle can, by means of the key 3, exchange information with the key 3 via the control device bus, the transponder coil 10 and the transponder interface 10. Alternatively, data transmission by infrared, LF (low frequency) technology for the near area and LF technology for the far area is possible.

The key 3 can also have a counting device that enables the user to use the key only once to update the software in the control device 1. This prevents the unauthorized transfer of a functional key to a different person, without the knowledge of the vehicle manufacturer. This prevents the key from being circulated with an obsolete software version when later software versions are already available.

After programming, the key 3 is again useable. When the key 3 is returned by the end customer to the vehicle manufacturer (for example by mail), something that can be encouraged by offering suitable inducements for the end customer, the key 3 can be reused by the vehicle manufacturer for further/other software updates.

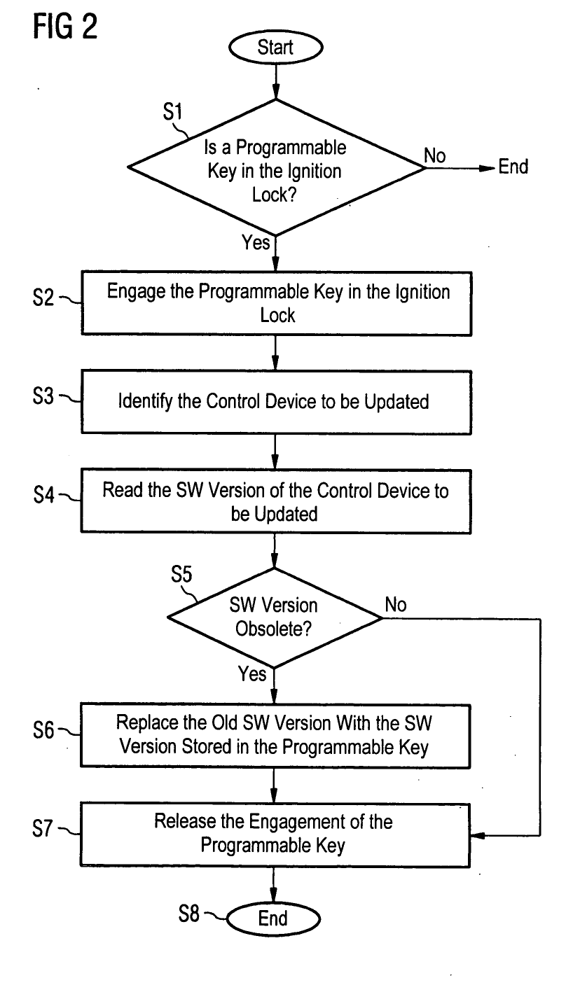

An example of the functioning of the described system according to FIG. 1 is explained in the following in FIG. 2 with the aid of a flow diagram.

In step S1, it is determined, for example by means of the diagnostic unit 6, whether the key 3 is inserted into ignition lock 9. If this is the case, the programmable key 3 is engaged in the ignition lock 9 in step S2. This prevents the key 3 being inadvertently withdrawn from the ignition lock during the transmission of software between the control device 1 and the key 3, before the transmission has been completed. The incomplete loading of the software to the memory 2 of the control device 1 is thus prevented.

In step S3, the control device 1 being updated is first identified from a group of control devices in the vehicle before the actual software update. In step S4, the diagnostic unit 6 reads the current software version of the control device 1 to be updated, in order to determine in step S5 whether the software version in the control device 1 is obsolete and is thus to be replaced.

If it is determined in step S5 that the software contained in the memory 2 of the control device 1 is obsolete, the new software version contained in the memory 5 of the key 3 is transmitted via the transponder interface 8 of the key 3 and via the transponder coil 10 of the ignition lock 9 to the control device 1, in the vehicle, to be updated and the old software version contained in the memory 2 of the control device 1 is replaced by the latest software version. After completion of the transmission or updating of the software in the control device 1, the key 3 is disengaged in step S7 and can be withdrawn from the ignition lock 9 by the user.

If in step S5 it is determined that the latest software version is already stored in the memory 2 of the control device 1, the process continues directly to step S7 as shown in the flow diagram and the engagement of the key 3 is ended, so that the key can be removed from the ignition lock 9 by the user.

In a variation of the method described above, steps S4 and S5 can, for example, be omitted and a software update automatically performed immediately the key is inserted into the ignition lock or brought into its vicinity.

It is also possible to update the software of all control devices in the vehicle automatically, so that step S3 of the aforementioned method shown in FIG. 1 can be omitted.

The method in accordance with the invention for updating the software in a control device 1 in a vehicle ends in step S8.

It will be understood by those of skill in the art, and it is indeed self-explanatory, that the aforementioned method and the system can be used simultaneously for a group of control devices 1.

It is also equally possible to form modifications and changes without departing from the protective scope of the invention. It is thus, for example, possible to use a different suitable construction for the portable hand-held device 3. The only decisive factor is that the design of the hand-held device 3, that has the update software, is of such a type that it can be supplied by the vehicle manufacturer/supplier to the end customer in a simple manner, for example by posting in an envelope.

The hand-held device 3 may, for example, also be in the form of a cigarette lighter that has to be inserted into the cigarette lighter socket, or in the form of a chip card that has to be inserted into a corresponding slot or brought into its vicinity in order to transmit data to the control devices in the vehicle (control devices fitted in the vehicle) or to receive data from same.

This application claims the priority, under 35 U.S.C. § 119, of German patent application No. 10 2004 002 911.3, filed Jan. 20, 2004; the entire disclosure of the prior application is herewith incorporated by reference.

1. In a system for the exchange of data between a vehicle-mounted control device and a portable device having software for transmission to the vehicle-mounted control device stored therein, the improvement wherein the portable device has a diagnostic unit for identification of software in the vehicle-mounted control device.

2. The system according to claim 1, wherein said portable device is a key and the vehicle-mounted control device communicates with the key via an ignition lock of the vehicle when the key is inserted in the ignition lock.

3. The system according to claim 2, which comprises a transponder coil in the ignition lock for wireless communication with said key and for supplying power to said key.

4. The system according to claim 1, wherein the portable device has a loading unit for transmission of the software stored in the portable device to the vehicle-mounted control device.

5. A method for exchanging data between control devices for a vehicle, the method which comprises:
reading a software version of at least one vehicle-mounted control device with a portable hand-held device;
comparing the software version of the vehicle-mounted control device with a software version stored in the hand-held device, by means of a diagnostic unit of the portable hand-held device; and
if the software version of the vehicle-mounted control device is older than the software version stored in the hand-held device, transmitting the software stored in the hand-held device to the at least one vehicle-mounted control device.
